(19) United States
(12) Patent Application Publication
(10) Pub. No.: US 2025/0280063 A1
(43) Pub. Date: Sep. 4, 2025

(54) Display Chassis Grounding

(71) Applicant: Google LLC, Mountain View, CA (US)

(72) Inventors: Peter Bevelacqua, Sunnyvale, CA (US); Huanyu Chen, Fremont, CA (US); Cheng-Jung Lee, San Jose, CA (US); Sunny Kung, Taipei (TW); Daniel Lin, Taipei (TW)

(73) Assignee: Google LLC, Mountain View, CA (US)

(21) Appl. No.: 18/592,109

(22) Filed: Feb. 29, 2024

(51) Int. Cl. H04M 1/02

(52) U.S. Cl. CPC H04M 1/0266

(57) ABSTRACT

Various arrangements for positioning a ground are described herein. A display is mounted within a first area of an enclosure of the electronic device. An antenna, configured to operate at one or more frequency bands, mounted within a second area of the enclosure that is outside of the first area; and one or more grounds positioned beneath the display and within the first area of the electronic device, wherein the one or more grounds are configured to provide grounding for the display and are positioned at or near a distance that is a quarter-wavelength associated with one or more wavelengths of the one or more of the frequency bands of the antenna.

### BACKGROUND

Electronic devices, such as tablet computing devices and mobile phones, include one or more antennas for use in wireless communication. Antennas require good grounding between large metal sections of the devices and the antennas. Without reliable grounding, the performance of the antennas is less predictable, less stable, and prone to loss modes that hinder the ability of the antenna to receive and transmit energy. For example, the electronic devices may include functionality to communicate using one or more WiFi bands (e.g., 2.4 GHz, 5 GHz). It can be difficult, however, to incorporate antennas in today's electronic devices. Many electronic devices have metal structures with limited space to place the antennas. Further, degradation of the performance and efficiency of the antennas may result from proximity of the antennas to certain components (e.g., battery, metal plate), which can interfere with the electric signals on the antennas. Still yet, some electronic devices may have full metal enclosures, without an antenna window, that can significantly degrade antenna signals.

### SUMMARY

Various embodiments for display chassis grounding are described herein. Using the techniques described herein, the performance of an antenna can be improved by grounding techniques. In some examples, a chassis and the display are grounded at a distance that is at or near a quarter wavelength from the antenna which is located within a border region of an electronic device. Using transmission line theory and the equation for a quarter-wavelength transformer, the ground acts as a short circuit at the location of the ground 106 and an open circuit or high impedance at the edge of the display and the border region. This means that Zin, which is the impedance looking into the gap between the display and antenna 104 is infinite. Therefore, the RF current associated with the antennal will not flow, and lossy modes in the cavity can be reduced/eliminated.

A system of one or more computers can be configured to perform particular operations or actions by virtue of having software, firmware, hardware, or a combination of them installed on the system that in operation causes or cause the system to perform the actions. In some examples, one or more computer programs can be configured to perform particular operations or actions by virtue of including instructions that, when executed by data processing apparatus, cause the apparatus to perform the actions. One general aspect includes an electronic device. In some examples, the electronic device also includes a display mounted within a first area of an enclosure of the electronic device. The device also includes an antenna, configured to operate at one or more frequency bands, mounted within a second area of the enclosure that is outside of the first area. In some examples, the device also includes one or more grounds positioned beneath the display and within the first area of the electronic device, where the one or more grounds are configured to provide grounding for the display and are positioned at or near a distance that is a quarter-wavelength associated with one or more wavelengths of the one or more of the frequency bands of the antenna. Other embodiments of this aspect include corresponding computer systems, apparatus, and computer programs recorded on one or more computer storage devices, each configured to perform the actions of the methods.

Implementations may include one or more of the following features. In some examples, the electronic device where the one or more frequency bands includes one or more of a 4 GHz frequency band and a 5 GHz frequency band, and where the distance is within ten percent of three centimeters. The one or more grounds are further positioned based on a strength of a current of the antenna within the electronic device. In some examples, the one or more grounds include a first ground positioned based on a first quarter wavelength associated with a first frequency band and a second ground positioned based on a second quarter wavelength associated with a second frequency band. The one or more grounds are configured to simulate one or more of a short circuit or an open circuit. In some examples, the enclosure is metal. The antenna is a slot antenna. The one or more grounds may include one or more of a fabric over foams (FoF), a spring, or a screw. The one or more second grounds are positioned at or near a second distance that based on a second quarter of one or more second wavelengths associated with the second antenna. Implementations of the described techniques may include hardware, a method or process, or computer software on a computer-accessible medium.

One general aspect includes a system. The system also includes an electronic device that includes a metal enclosure. In some examples, the system also includes a display mounted within a first area of the metal enclosure of the electronic device. In some examples, the system also includes a wireless fidelity (WIFI) antenna mounted within a second area of the electronic device. The system also includes one or more grounds positioned beneath the display and within the first area of the electronic device, where the one or more grounds are configured to provide grounding for the display and are positioned at or near a distance that is a quarter-wavelength associated with one or more wavelengths of one or more frequency bands of the WIFI antenna. Other embodiments of this aspect include corresponding computer systems, apparatus, and computer programs recorded on one or more computer storage devices, each configured to perform the actions of the methods.

Implementations may include one or more of the following features. The system where the one or more grounds are further positioned based on a strength of a current of the antenna within the electronic device. In some examples, the one or more grounds include a first ground positioned based on a first quarter wavelength associated with a first frequency band and a second ground positioned based on a second quarter wavelength associated with a second frequency band. The one or more grounds are configured to simulate one or more of a short circuit or an open circuit. In some examples, the antenna is a slot antenna. In some examples, the one or more grounds may include one or more of a fabric over foams (FoF), a spring, or a screw. The one or more second grounds are positioned at or near a second distance that based on a second quarter of one or more second wavelengths associated with the second antenna. Implementations of the described techniques may include hardware, a method or process, or computer software on a computer-accessible medium.

One general aspect includes a method for positioning a display ground to enhance operation of an antenna. In some examples, the method also includes determining a frequency band associated with an antenna mounted at a first location within a first area of an electronic device. In some examples, the method also includes determining a strength of a current generated by the antenna at one or more locations within the electronic device. The method also includes determining, based at least in part on the strength of the current and a quarter wavelength associated with the frequency band, a location within a second area of the electronic device to position a ground, where the ground is positioned on an underside of the display and within the second area. In some examples, the method also includes mounting the ground at the location. Other embodiments of this aspect include corresponding computer systems, apparatus, and computer programs recorded on one or more computer storage devices, each configured to perform the actions of the methods.

Implementations may include one or more of the following features. The method where the frequency band is one or more of a 2.4 GHz frequency band, a 5 GHz frequency band, and a 6 GHz frequency band. The ground is configured to simulate one or more of a short circuit or an open circuit. The second ground is positioned on an underside of the display and within the second area; and mounting the ground at the location. Implementations of the described techniques may include hardware, a method or process, or computer software on a computer-accessible medium.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a top view of a portion of an electronic device that includes an antenna and a display ground.

FIG. 2 illustrates a top view of a portion of an electronic device that includes multiple antennas and display grounds.

FIG. 3 illustrates a cross section that shows an antenna within the electronic device and a display ground positioned a quarter-wavelength from the antenna.

FIG. 4 illustrates a cross section that shows an antenna mounted within the border region of an electronic device.

FIG. 5 illustrates an embodiment of a method that includes positioning a ground based on a quarter-wavelength of a frequency band of an antenna to increase the efficiency of the antenna.

FIG. 6 shows some components of an electronic computing device, such as a tablet.

### DETAILED DESCRIPTION

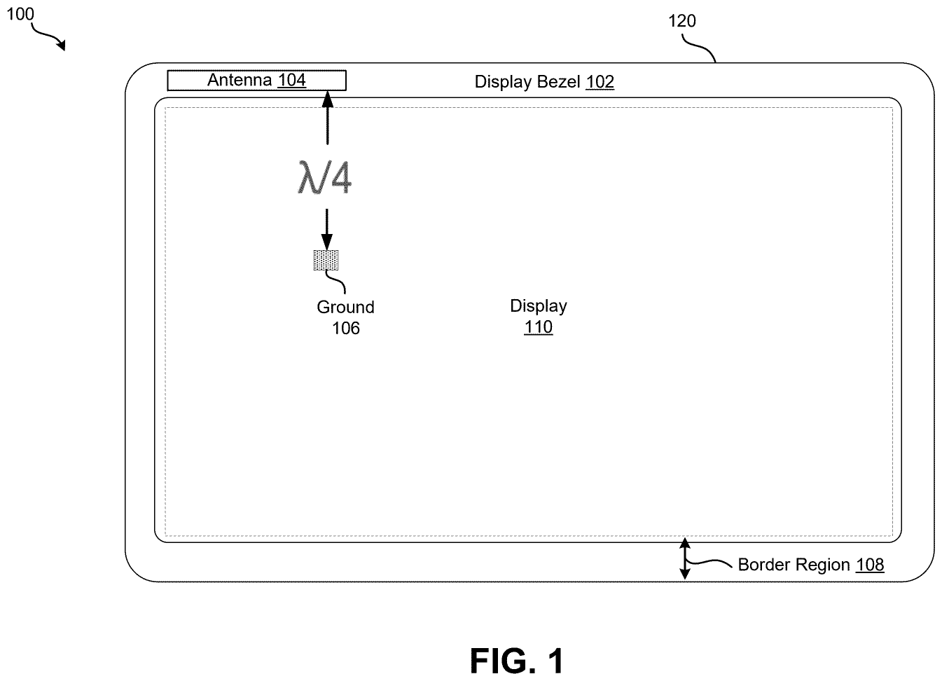

FIG. 1 illustrates a top view 100 of a portion of an electronic device 120 that includes an antenna 104 and a display ground 106. While one antenna is illustrated in FIG. 1, more than one antenna can be mounted in the enclosure of electronic device 120. According to some configurations, the antenna 104 is a slot antenna. In other configurations, the antenna may be a different type of antenna, such as but not limited to Planar Inverted-F (PIFA) antennas, regular patch antennas, dipole antennas, and the like.

In some examples, the electronic device 120 may be a tablet computing device, or some other mobile computing device that includes one or more antennas, such as antenna 104. According to some configurations, the electronic device 120 has a full metal enclosure that does not include an antenna window. In the current example, the antenna 104 is a wireless fidelity (WIFI) slot antenna that emits radiation from the enclosure. As illustrated, the antenna 104 can operate at one or more frequency bands (e.g., 2.4 GHz, 5 GHz, 6 GHz bands).

While one antenna 104 is illustrated, more antennas may be included in other examples. Further, the antennas may be configured to operate at one or more different bands. For example, one antenna may operate at the 2.4 GHz band, another antenna may operate at the 5 GHz band, and another antenna may operate at the 6 GHz band. In other examples, an antenna may operate at both the 2.4 GHz band and the 5 GHz band. Other antenna configurations can also be used.

In the example illustrated in FIG. 1, the electronic device 120 includes a full metal enclosure in which different components of the electronic device are located. As illustrated, antenna 104 is placed near a first corner of the electronic device 120 within the border region 108. The antenna 104 and may include any suitable structure that enables single or multi-band functionality. In some examples, the antennas are MIMO wireless-fidelity antennas (e.g., 2×2 highly efficient MIMO triband antennas, Wi-Fi 2.4 GHz, 5 GHz, 6 GHz) placed within open cavities formed between a display (e.g., narrow display bezel) and an enclosure (e.g., metal disclosure) of a user equipment (UE), such as a tablet). In other examples, different types of antennas can be used.

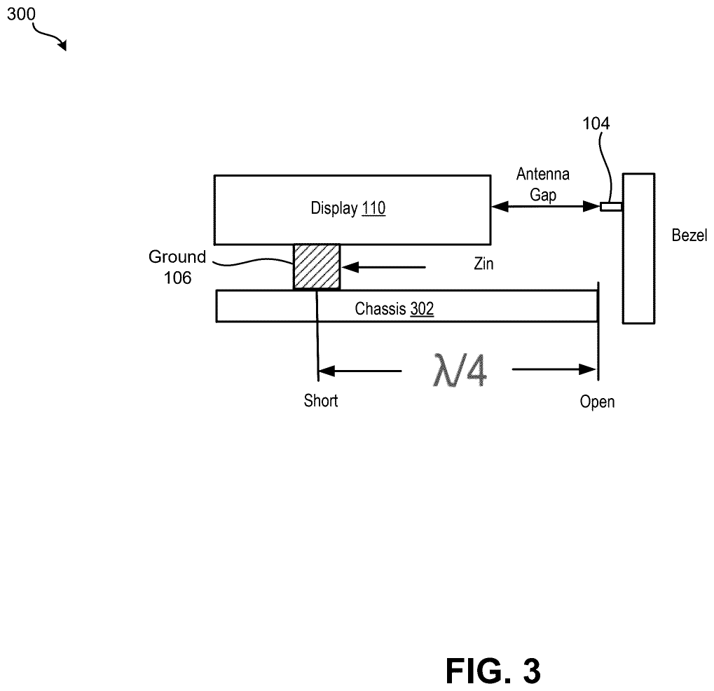

In many cases, an electronic device 120 has a constrained space that can make antenna placement difficult. In some configurations, the enclosure of the electronic device 120 includes a metal bucket or midframe (“the chassis” See FIG. 3) that provides the physical structure/skeleton of the electronic device 120. Another large metallic object of the electronic device 120 is the display 104. Generally, the backside of the display 104 is essentially a large rectangular metal sheet.

According to some configurations, antennas, such as antenna 104, are mounted near the edge of the electronic device 120 that is in a “display keepout” area, which may also be referred to herein as “the border region”. As used herein, the border region is the area of the electronic device 120 that extends from the physical edges of the display to the physical edge of the device 120. In some cases, antennas are mounted underneath the display bezel 102.

As briefly discussed above, antennas benefit from good grounding between large metal sections of the device (e.g., the display) and the antenna. Without reliable grounding, antenna performance is less predictable, less stable, and prone to loss modes that hinder the ability of the antenna to receive and transmit energy.

Grounding of the display 110 and the housing is important for different components of the electronic device 120, such as the operation of antenna 104, but in some cases (e.g., due to the display flex which is the flexible printed circuit “PCB” that connects the display to the MLB and the touch flex), it is not always possible to ground the display 110 and the housing at the preferred location for operation of an antenna 104.

Using techniques described herein, the performance of antenna 104 can be improved by grounding techniques. Referring to FIG. 3, in some examples, the chassis 302 and the display 110 are grounded (e.g., at ground 106) at a distance that is at or near a quarter wavelength from the antenna 104 which is located within the border region 108 of electronic device 120. Using transmission line theory and the equation for a quarter-wavelength transformer, the short circuit created by the ground 106 acts as a short circuit at the location of the ground 106 and an open circuit or high impedance at the edge of the display 110 and the border region. This means that Zin, which is the impedance looking into the gap between the display 110 and antenna 104 is infinite. Therefore, the RF current associated with the antennal will not flow, and lossy modes in the cavity can be reduced/eliminated.

As an example, the quarter-wavelength distance to enhance an antenna 104 operating at 2.5 GHz is roughly 3 cm which is obtained by determining the wavelength of the target frequency (e.g., 12 cm for 2.5 GHz) divided by four (12/4) which is equal to 3 cm. In the current example, ground 106 also acts as a good ground for 5 GHz. At 5 GHz (the upper WIFI band), the separation is a half-wavelength, in which case transmission line theory shows that Zin is equal to zero since a short is reflected into a short for multiples of a half-wavelength. In this way, ground 106 that is away from the edge of the display 110 can achieve the same effect, which can be advantageous for implementation reasons.

By utilizing the grounding techniques described herein that are at specific locations away from the edge, antenna performance is enhanced while also achieving the physical constraints of the electronic device 120. Placing the ground 106 away from the edges helps to avoid the issue of using grounding that touches the display flex or touch flex, which are often sensitive to any force applied.

In some examples, one or more grounding structures can be used to ground the display 110 to the chassis 302. According to some configurations, a grounding foam is used. In some examples, the grounding structure can be compressed when the display component is placed on top of the grounding structure. In other examples, the decoupling structure may be a metal spring clip, screw, and/or some other material could that is directed at grounding the display.

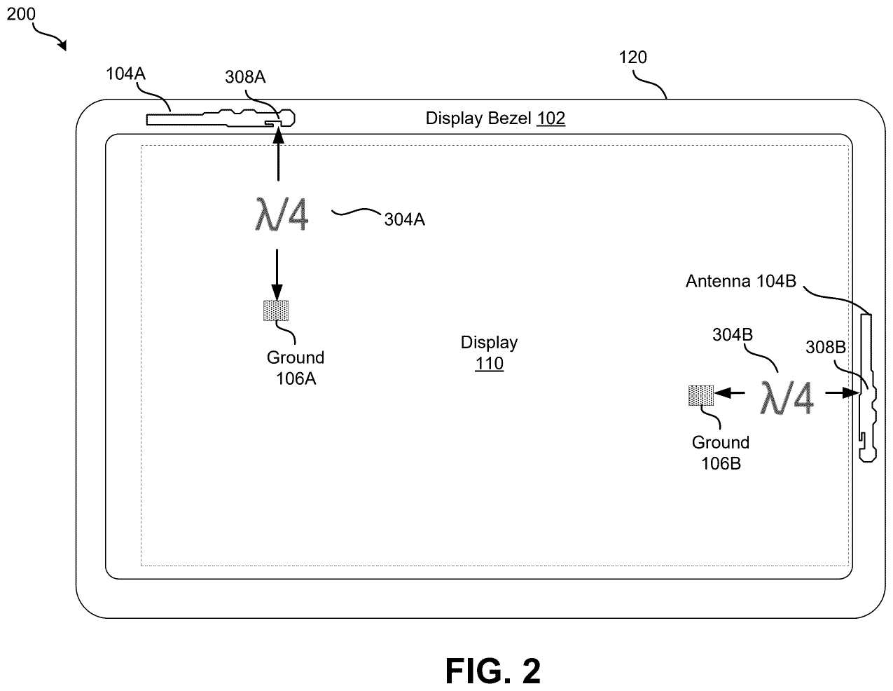

FIG. 2 illustrates a top view 200 of an electronic device 120 that includes two antennas operating at different frequency bands. As discussed above, the electronic device 120 may be a tablet computing device, or some other mobile computing device that includes one or more antennas, such as a plurality of antennas that are enclosed within a metal enclosure that does not include an antenna window.

In the illustrated example, the first antenna 104A is located beneath the display bezel 102 near a top corner of the electronic device and the second antenna 302B is located on the side of electronic device 120 and underneath the display bezel 102. For purposes of explanation, antenna 104A is operating at the same frequency band 2.4 GHz as antenna 104 illustrated in FIG. 1, and antenna 104B is operating at the 6 GHz frequency band.

As discussed above, the quarter-wavelength distance 304A is approximately 3 cm for antenna 104 operating at a frequency band of 2.4 GHz to 2.5 GHz. For antenna 104B that is operating at a 6 GHz frequency band, the quarter wavelength distance 304B is 1.5 cm (6 cm/4).

In some configurations, to determine the location to place a ground 106, the strength of the current associated with an antenna 104 is measured and/or simulated (e.g., using simulation tools) to determine where the current is the strongest to assist in determining where to position the ground 106. For example, if the current for antenna 104A is strongest at location 308A, then the ground 106A may be placed at or near 3 cm from location 308A. Similarly, if the current for antenna 104B is strongest at location 308B, then the ground 106A may be placed at or near 1.5 cm from location 308B.

Using either FoFs, springs, or screws, requires sufficient space and height within the device 120. In addition, even with sufficient area, grounding can increase the force which pushes the display 110 away from the enclosure, raising structural risks. For some types of displays, such as Organic Light-Emitting Diode (OLED) displays, the display flex at the edge (where the flex wraps around or bends) can be fragile, so grounding at the edge can be risky. Using the techniques described herein, to help prevent force pushing ICs and to limit the force caused by grounding structures, one or more grounding structures may be placed farther away from the antenna 104 and toward the center of the display 110. Since one or more the grounding structures may be placed more toward the center of display 110, the structural concerns of placing grounding structures toward the edge of the display 110 can be reduced.

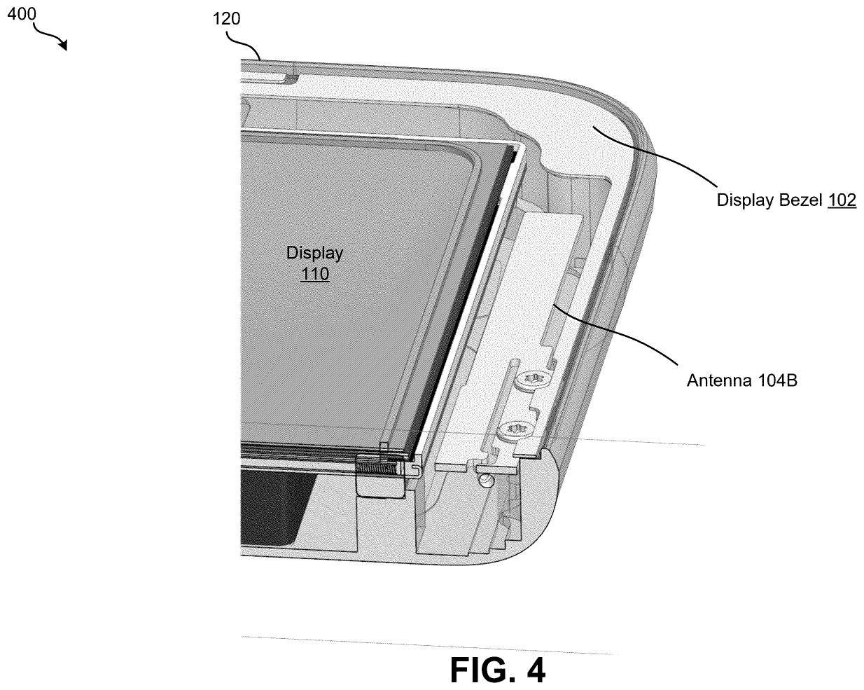

FIG. 4 illustrates a top view 400 of an electronic device 120 that has a narrow display bezel 102. As illustrated, an electronic device 120, such as a tablet computing device, has a display bezel 102 that surrounds the display 110. In the current example, the display bezel is a narrow width (e.g., less than 10 mm, 12 mm, . . . ). According to some configurations, the display 110 may be disposed on top of a full metal enclosure that does not include an antenna window. As discussed above, the performance and efficiency of antennas can be degraded from proximity of the antennas to certain components (e.g., battery, metal plate), which can interfere with the electric signals on the antennas.

As illustrated, antenna 104B can be placed within a border region of electronic device 120 that is near the edge of the device 120. Using the techniques described herein, one or more grounds 106 (not shown in FIG. 4) can be positioned (e.g., based on the frequency band(s) of antenna 104B) beneath and toward the center of display 110 to improve the efficiency of the antenna 104B and to reduce the impact of placing a ground near the edge of the display 110.

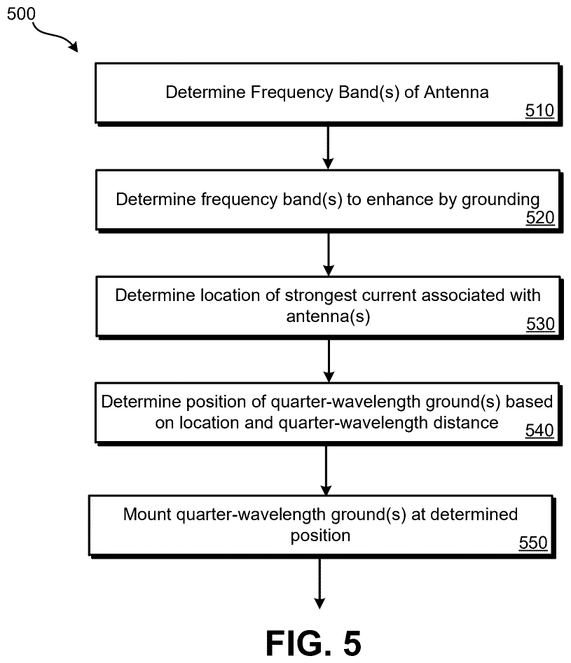

Various methods may be performed using the systems, states, and arrangements detailed in relation to FIGS. 1-4. FIG. 5 illustrates a method that may be performed to position a ground based on a quarter-wavelength of a frequency band of an antenna 104 to increase the efficiency of the antenna 104.

At 510, the frequency band(s) of an antenna 104 included within an electronic device 120 are determined. In some examples, the electronic device 120 has a full metal enclosure that does not include an antenna window. The antenna 104 is configured to emit radiation from the enclosure. In some examples, the slot antenna 104 is a WIFI antenna that can operate at one or more bands (e.g., 2.4 GHz, 5 GHz, 6 GHz bands). As discussed above, to improve the efficiency of the antenna(s) 104 included within the device, one or more grounds 104 can be placed one quarter-wavelength away from the antenna 104 toward the center of the display 110.

At 520, the frequency band(s) to enhance by grounding for the one or more antennas 104 are determined. As discussed above, a ground 106 may be positioned to improve the efficiency of an antenna at one or more frequency bands (e.g., 2.4 GHz, 5 GHz, 6 GHz, and the like.).

At 530, a determination is made to identify the location near the antenna(s) where the current associated with a particular frequency band is the strongest. As discussed above, to increase the efficiency of antenna 104 (e.g., near the 2.4 GHz frequency), a ground 106 is positioned approximately 3 cm from the antenna.

At 540, the position of the ground 106 is determined. As discussed above, the ground 106 position is based on the location where the current of the antenna at the determined frequency band is the strongest. The ground 106 position can also be placed on other constraints, such as but not limited to physical constraints of the electronic device 120.

At 550, the ground(s) 106 are mounted at the determined position. As discussed above, the ground(s) 106 may be placed toward the center of the display 106 (instead of near the edge of the display).

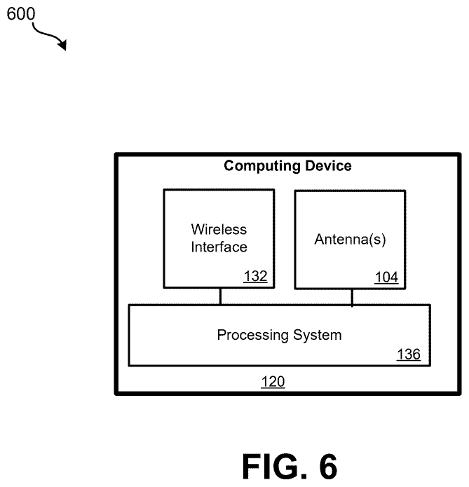

FIG. 6 shows some components of an electronic computing device 120, such as a tablet. Specifically, device 120 include: wireless interfaces 132; antenna(s) 104, and processing system 136. As illustrated in different drawings, the device 130 may have many other components, such as but not limited to microphones, speakers, a full metal enclosure, a display, a bezel, and the like.

Computing device 120 includes wireless interface 132 and processing system 136. Examples of computing device 120 can include: a smartphone; a desktop, laptop, or tablet computer; a gaming device; a smart television; a digital music player device; a smartwatch; smart glasses; an augmented reality or a virtual reality headset; or any other device. Computing device 120 includes wireless interface 132, which can wirelessly communicate with other devices, using one or more types of communication protocols.

Processing system 136 may include one or more special-purpose or general-purpose processors. Such special-purpose processors may include processors that are specifically designed to perform the functions of the components detailed herein, such as detailed in relation to processing systems 126.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. An electronic device, comprising:
a display mounted within a first area of an enclosure of the electronic device;
an antenna, configured to operate at one or more frequency bands, mounted within a second area of the enclosure that is outside of the first area; and
one or more grounds positioned beneath the display and within the first area of the electronic device, wherein the one or more grounds are configured to provide grounding for the display and are positioned at or near a distance that is a quarter-wavelength associated with one or more wavelengths of the one or more of the frequency bands of the antenna.

2. The electronic device of claim 1, wherein the one or more frequency bands includes one or more of a 2.4 GHz frequency band and a 5 GHz frequency band, and wherein the distance is within ten percent of three centimeters.

3. The electronic device of claim 1, wherein the one or more grounds are further positioned based on a strength of a current of the antenna within the electronic device.

4. The electronic device of claim 1, wherein the one or more grounds include a first ground positioned based on a first quarter wavelength associated with a first frequency band and a second ground positioned based on a second quarter wavelength associated with a second frequency band.

5. The electronic device of claim 1, wherein the one or more grounds are configured to simulate one or more of a short circuit or an open circuit.

6. The electronic device of claim 1, wherein the enclosure is metal.

7. The electronic device of claim 1, wherein the antenna is a slot antenna.

8. The electronic device of claim 1, wherein the one or more grounds comprise one or more of a fabric over foams (FoF), a spring, or a screw.

9. The electronic device of claim 1, further comprising:
a second antenna operating at one or more second frequency bands mounted within the second area; and
one or more second grounds positioned beneath the display and within the first area of the electronic device, wherein the one or more second grounds are positioned at or near a second distance that based on a second quarter of one or more second wavelengths associated with the second antenna.

10. A system, comprising:
an electronic device that includes a metal enclosure;
a display mounted within a first area of the metal enclosure of the electronic device;
a wireless fidelity (WIFI) antenna mounted within a second area of the electronic device; and
one or more grounds positioned beneath the display and within the first area of the electronic device, wherein the one or more grounds are configured to provide grounding for the display and are positioned at or near a distance that is a quarter-wavelength associated with one or more wavelengths of one or more frequency bands of the WIFI antenna.

11. The system of claim 10, wherein the one or more grounds are further positioned based on a strength of a current of the antenna within the electronic device.

12. The system of claim 10, wherein the one or more grounds include a first ground positioned based on a first quarter wavelength associated with a first frequency band and a second ground positioned based on a second quarter wavelength associated with a second frequency band.

13. The system of claim 10, wherein the one or more grounds are configured to simulate one or more of a short circuit or an open circuit.

14. The system of claim 10, wherein the antenna is a slot antenna.

15. The system of claim 10, wherein the one or more grounds comprise one or more of a fabric over foams (FoF), a spring, or a screw.

16. The system of claim 10, further comprising:
a second antenna operating at one or more second frequency bands mounted within the second area; and
one or more second grounds positioned beneath the display and within the first area of the electronic device, wherein the one or more second grounds are positioned at or near a second distance that based on a second quarter of one or more second wavelengths associated with the second antenna.

17. A method for positioning a display ground to enhance operation of an antenna, comprising:
determining a frequency band associated with an antenna mounted at a first location within a first area of an electronic device;
determining a strength of a current generated by the antenna at one or more locations within the electronic device;
determining, based at least in part on the strength of the current and a quarter wavelength associated with the frequency band, a location within a second area of the electronic device to position a ground, wherein the ground is positioned on an underside of the display and within the second area; and
mounting the ground at the location.

18. The method of claim 17, wherein the frequency band is one or more of a 2.4 GHz frequency band, a 5 GHz frequency band, and a 6 GHz frequency band.

19. The method of claim 17, wherein the ground is configured to simulate one or more of a short circuit or an open circuit.

20. The method of claim 17, further comprising:
determining a second frequency band associated with a second antenna mounted at a second location within the first area of the electronic device;
determining a second strength of the current generated by the second antenna at one or more locations within the electronic device;
determining, based at least in part on the second strength of the current and a second quarter wavelength associated with the second frequency band, a second location within the second area of the electronic device to position a second ground, wherein the second ground is positioned on an underside of the display and within the second area; and
mounting the ground at the location.
